(19) United States
(12) Patent Application Publication
(10) Pub. No.: US 2008/0056872 A1
(43) Pub. Date: Mar. 6, 2008

(54) Vehicle Passenger Lift

(76) Inventors: Scott Alan Darnell, Greenville, IL (US); David Wayne Gotter, Brighton, IL (US)

Correspondence Address: QUICKPATENTS, INC., 32861 CALLE PERFECTO, SUITE A, SAN JUAN CAPISTRANO, CA, 92675, US

(21) Appl. No.: 11/849,283

(22) Filed: Sep. 1, 2007

Related U.S. Application Data
(60) Provisional application No. 60/841,637, filed on Sep. 1, 2006.

(51) Int. Cl. B66F 11/00

(52) U.S. Cl. 414/546

(57) ABSTRACT

Disclosed is a system for lifting a wheelchair into and out of a vehicle. A bearing mount is fixed to the vehicle rotationally captures a pivot rod to which a rear mounting plate is fixed. Two pairs of parallel arms are pivotally fixed between the rear mounting plate and a front mounting plate, such that the arms and mounting plates form a parallelogram therebetween. A pair of forks are horizontally mounted to the forward mounting plate and are adapted to engage a pair of horizontal fork receivers that are fixed to the wheelchair. At least one vertical linear actuator is fixed between the mounting plates and is adapted to selectively raise and lower the forward mounting plate and forks with respect to the vehicle. At least one horizontal linear actuator is fixed between the vehicle and the rear mounting plate. The horizontal linear actuator is adapted to selectively rotate the forward mounting plate, arms, and the pair of forks between the inside and outside positions.

### CROSS-REFERENCE TO RELATED APPLICATIONS

This application claims the benefit of U.S. Provisional Patent Application 60/841,637, filed on Sep. 1, 2006.

### STATEMENT REGARDING FEDERALLY SPONSORED RESEARCH AND DEVELOPMENT

Not Applicable.

### FIELD OF THE INVENTION

This invention relates to automatic lifts, and more particularly to a passenger wheelchair lift device for a vehicle.

### DISCUSSION OF RELATED ART

Disabled persons, such as those confined to wheelchairs, have limited options pertaining to driving vehicles. Typically, vehicles that are available to disabled persons are necessarily large vehicles, such as vans, which provide internal room sufficient to contain prior art wheelchair lift or ramp devices. Such prior art wheelchair lift devices are taught, for example, in the following patents and patent applications:

| Patent No. | Inventor(s) | Issue Date |
|---|---|---|
| 2005/0214104 | Strong | Sep. 29, 2005 |
| 6,582,181 | Suehiro et al. | Jun. 24, 2003 |
| 6,357,992 | Ringdahl et al. | Mar. 19, 2002 |
| 5,746,465 | Jones et al. | May 5, 1998 |
| 5,542,811 | Vartanian | Aug. 6, 1996 |
| 5,540,539 | Wolfman et al. | Jun. 30, 1996 |
| 5,401,135 | Stoen et al. | Mar. 28, 1995 |
| 5,308,214 | Crain et al. | May 3, 1994 |
| 4,907,936 | Bourdage | Mar. 13, 1990 |
| 4,551,060 | Quercy | Nov. 05, 1985 |
| 4,483,653 | Waite | Nov. 20, 1984 |
| 4,476,959 | Tortellier | Oct. 16, 1984 |
| 4,456,421 | Robson | Jun. 26, 1984 |
| 4,270,630 | Karkau | Jun. 2, 1981 |
| 4,265,586 | Couture | May 5, 1981 |

Prior art ramp-type devices require the most room inside a vehicle, since a pathway from the ramp—typically on the side of the vehicle—to the driver's seat area of the vehicle must be kept clear. As such, vehicles with ramp-type prior art devices, such as taught in the Couture, Karkau, Robson, Quercy, Tortellier, Bourdage, Crain et al., Stoen et al. Vartanianand Ringdahl et al. patents, must necessarily be larger-sized vehicles, which is not always desirable, particularly for stowing in a standard sized garage.

Other prior art lift devices, such as taught in the Wolfman et al. and Jones et al. patents, include a dedicated chair assembly that is fixed to a lift mechanism of the vehicle. To use such a device, a wheelchair-bound driver of such a vehicle must transfer from his wheelchair to the chair of the vehicle. Likewise, when exiting the vehicle, the driver must transfer back to his wheelchair. Aside from the obvious drawbacks of having to transfer between chairs, which is time consuming, the driver must also be able to readily store his wheelchair somewhere in the vehicle.

Other prior art devices, such as taught in the Waite and Suchiro et al. patents, teach a lift device that works with a specific type of wheelchair having retractable wheels. To use such a device, the driver must use the wheelchair that comes with these lift devices. But such wheelchairs are cumbersome for normal use since they have extra wheel retracting mechanisms and are not as easy to use outside of the vehicle as conventional wheelchairs.

Finally, the Strong patent application teaches a mechanism that can be used with an existing wheelchair provided the existing wheelchair is fitted with a lift plate that cooperates with a lift arm of the device. Once a wheelchair has the lifting plate attached, engaging the wheelchair with the device is difficult, however. Further, such a device provides no means for moving the wheelchair towards the steering wheel of the vehicle when inside the vehicle. As such, if the occupant wishes to be closer to steering wheel or pedals of the vehicle, the user must disengage himself from the lift arm. Yet disengaging from the lift arm reduces the safety of the device in use, since the wheelchair is then no longer kept in place by the lifting mechanism.

Therefore, there is a need for wheelchair lifting device for use with a vehicle that allows the wheelchair to be easily engaged to the lift device with minimal modification to the wheelchair. Such a needed device would use little room within the vehicle and could be used with relatively smaller vehicles. Further, such a needed device would serve to keep the wheelchair in place laterally and vertically within the vehicle when in place in the driver's area proximate the steering wheel and pedals of the vehicle while allowing the wheels of the wheelchair to rest on the floor of the vehicle. The present invention accomplishes these objectives.

### SUMMARY OF THE INVENTION

The present device is a system for lifting a person in a wheelchair into and out of a vehicle. A bearing mount is fixed to the vehicle and includes a bearing mounting means and a vehicle mounting means. A pivot rod is rotationally captured within the bearing means and is free to rotate therein, but maintains a preferably vertical orientation.

A rigid rear mounting plate is fixed to the pivot rod and includes a pair of arm mounting means that are each pivotally mounted to a rear end of each of two pairs of parallel arms. A forward end of each parallel arm is pivotally mounted to a substantially vertical front mounting plate, such that the arms and mounting plates form a parallelogram therebetween and the mounting plates each remain oriented substantially consistently and preferably vertically. As such, the front mounting plate is free to be raised or lowered with respect to the rear mounting plate, the arms each pivoting with respect to the mounting plates.

A pair of rigid metal forks are horizontally mounted to the forward mounting plate and are adapted to engage a pair of horizontal fork receivers that are fixed to the wheelchair.

At least one vertical linear actuator is fixed between the mounting plates and is adapted to selectively raise and lower the forward mounting plate and forks with respect to the vehicle. Preferably an actuator control is adapted to activate each linear actuator and is mounted to the forward mounting plate, such that an occupant of the wheelchair may reach the actuator control when the wheelchair is either fully engaged to the pair of forks or outside of the vehicle but not engaged to the pair of forks.

In use, the mounting plates, arms, and forks may rotate from an inside position inside the vehicle to a substantially outside position outside of the vehicle about the pivot rod. When in the inside position, each linear actuator is typically in a raised position. When the mounting plates, arms, and forks are rotated into the outside position, each linear actuator may be changed from the raised position to a lowered position.

Preferably at least one horizontal linear actuator is fixed between the vehicle and the rear mounting plate. The horizontal linear actuator is adapted to selectively rotate the forward mounting plates, arms, and the pair of forks between the inside and outside positions. In such an embodiment, a second actuator control is adapted to activate the horizontal linear actuator, and is mounted to the forward mounting plate preferably with the actuator control. As such, the wheelchair occupant may reach both actuator controls when the wheelchair is fully engaged to the pair of forks, or outside of the vehicle and not engaged to the forks by using a remote control or the like.

The present device is a wheelchair lifting device for use with a vehicle that allows the wheelchair to be easily engaged to the lift device with minimal modification thereto. The present invention uses little room within the vehicle and can be used with relatively small vehicles. Further, the present device serves to keep the wheelchair locked into place laterally and vertically within the vehicle when the device is in an inside-vehicle position. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a partial perspective exploded view of the invention;

FIG. 2A is a partial top plan view of the invention, illustrating the invention in an inside position;

FIG. 2B is a partial top plan view of the invention, illustrating the invention in an outside position;

FIG. 3A is a left side elevational view of the invention in a lowered position;

FIG. 3B is a partial left-side elevational view of the invention in a raised position;

FIG. 4 is a left-side elevational view of the invention, illustrated in an outside position an not engaged with a wheelchair; and

FIG. 5 is a left-side elevational view of the invention, illustrated in the raised and inside position, and engaged with the wheelchair.

### DETAILED DESCRIPTION OF THE PREFERRED EMBODIMENT

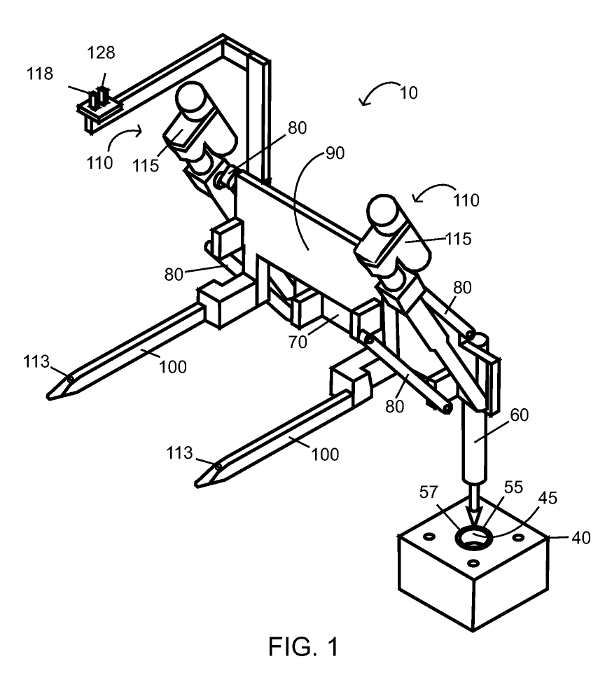

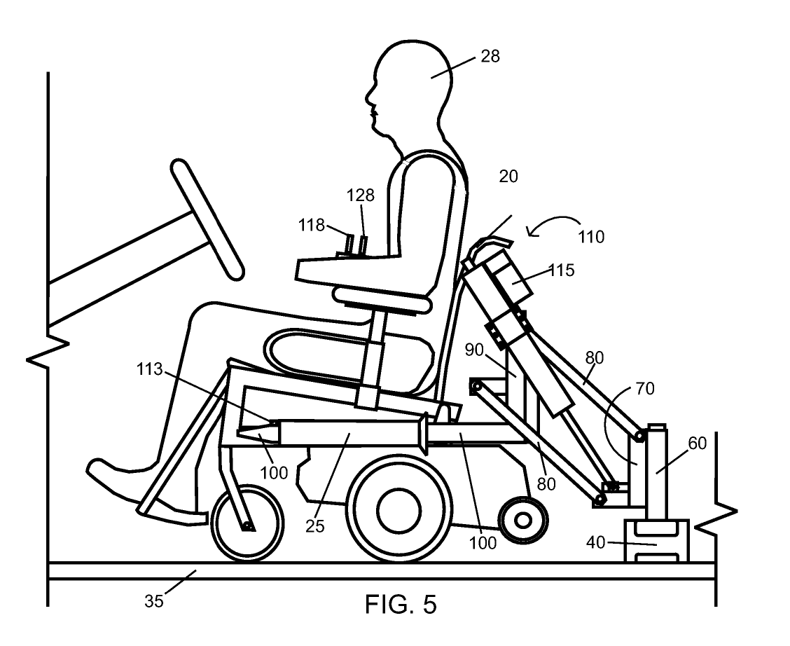

FIGS. 1 and 5 illustrate a system 10 for lifting an occupant 28 in a wheelchair 20 into and out of a vehicle 30. Such a vehicle 30 may be a Dodge Ram “Quad-Cab” truck, for example, or any other vehicle having so-called “suicide-swing” rear doors that open towards a forward door, providing ample room for the system 10. Other vehicles 30 may be modified to accommodate the system 10.

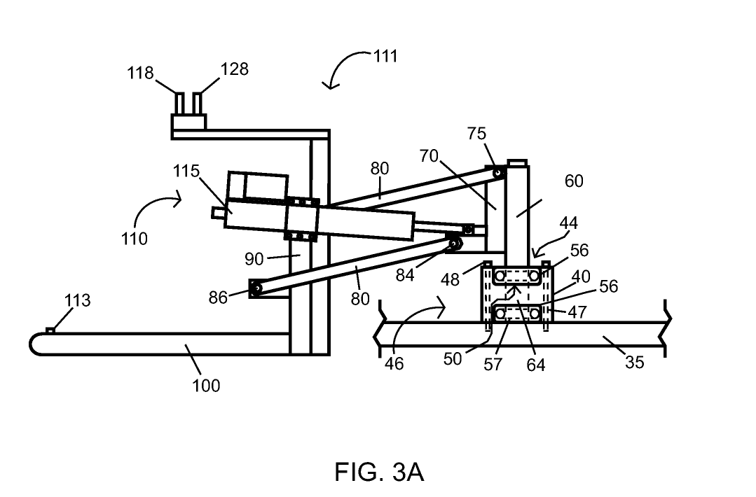

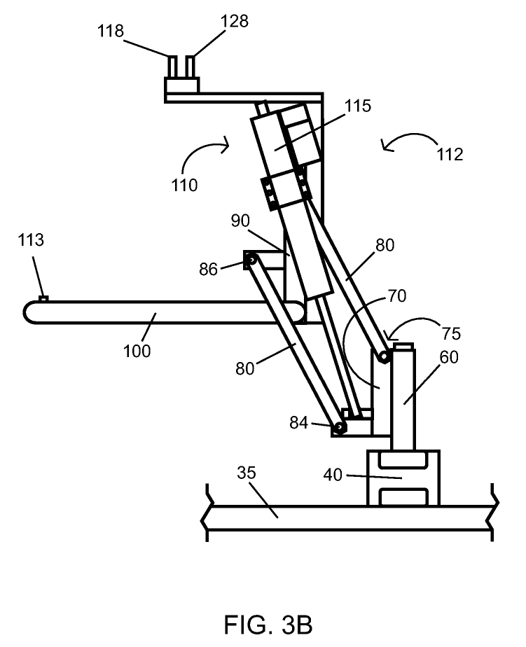

A bearing mount 40 is fixed to the vehicle 30 and includes a bearing mounting means 44 and a vehicle mounting means 46 (FIG. 3A). The bearing mounting means 44 is preferably an aperture 45 within the bearing mount 40 that is adapted to securely receive a bearing means 50. A pivot rod 60 has an upper end 66 and a lower end 64, the lower end 64 being rotationally captured within the bearing means 50. The bearing means 50 is preferably a pair of ball bearing housings 55 that each rotationally capture a plurality of ball bearings 56 and an inner ring 57, the inner ring 57 frictionally receiving the lower end 64 of the pivot rod 60. As such, the pivot rod 60 is free to rotate within the bearing means 50, but maintains a preferably vertical orientation. Both the bearing mount 40 and pivot rod 60 are preferably rigid metal so as to be able to support the weight of the wheelchair 20 and the system 10 pivotally thereon.

The vehicle mounting means 46 is preferably at least two apertures 47 in the bearing mount 40 through each of which a bolt 48 may be used to fasten the bearing mount 40 to the vehicle 30 (FIG. 3A). Other vehicle mounting means 46 may be used as desired, however, such as welding the mount 40 to the vehicle 30. Preferably the bearing mount 40 is fixed to a frame 35 of the vehicle 30 at a portion thereof proximate to a driver's side door (not shown), but can also be mounted proximate a passenger side door (not shown).

A rigid rear mounting plate 70 is fixed to the upper end 66 of the pivot rod 60 and includes a pair of arm mounting means 75 that are each pivotally mounted to a rear end 84 of a pair of parallel arms 80. Such arm mounting means 75 may be bolts, or the like. A forward end 86 of each parallel arm 80 is pivotally mounted to a substantially vertical front mounting plate 90, such that the arms 80 and mounting plates 70,90 form a parallelogram therebetween and the mounting plates 70,90 each remain oriented substantially consistently and preferably vertically (FIGS. 3A and 3B). As such, the front mounting plate 90 is free to be raised or lowered with respect to the rear mounting plate 70, the arms 80 each pivoting with respect to the mounting plates 70,90. The mounting plates 70,90 and arms 80 are each made from a rigid metal stock or carbon-fiber material, and are each strong enough to support the weight of the wheelchair 20 and the occupant 28.

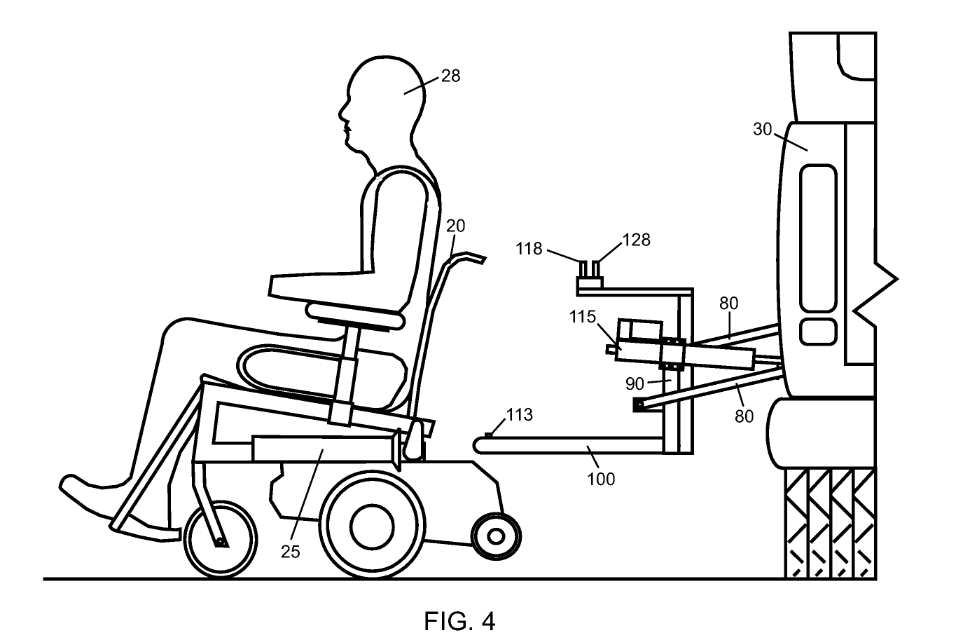

A pair of rigid metal or carbon-fiber forks 100 are mounted to the forward mounting plate 90 and are adapted to engage a pair of fork receivers 25 that are fixed to the wheelchair 20 (FIGS. 4 and 5). The fork receivers 25 are preferably metal or carbon-fiber tubes that are fixed to the wheelchair 20 with any suitable mounting means such as with bolts, welding, or the like (not shown). The fork receivers 25 are laterally spaced approximately the same distance apart as each metal fork 100. Each metal fork 100, moreover, may be adjusted on the forward mounting plate 90, such as by bolting each fork 100 to the forward mounting plate 90 at a desired location. A pin 113 fixed to each fork 100 serves to retain the receiver 25 onto the fork 100 when the fork 100 is in a raised position 112 (FIG. 3B).

At least one vertical linear actuator 110 is fixed between the mounting plates 70,90 and is adapted to selectively raise and lower the forward mounting plate 90 and forks 100 with respect to the rear mounting plate 70 and the vehicle 30. Preferably an actuator control 118 is adapted to activate each linear actuator 118 and is mounted to the forward mounting plate 90, such that an occupant 28 of the wheelchair 20 may reach the actuator control 118 when the wheelchair 20 is fully engaged to the pair of forks 100 (FIGS. 4 and 5), or outside of the vehicle with a remote control (not shown), as is commonly known in the art.

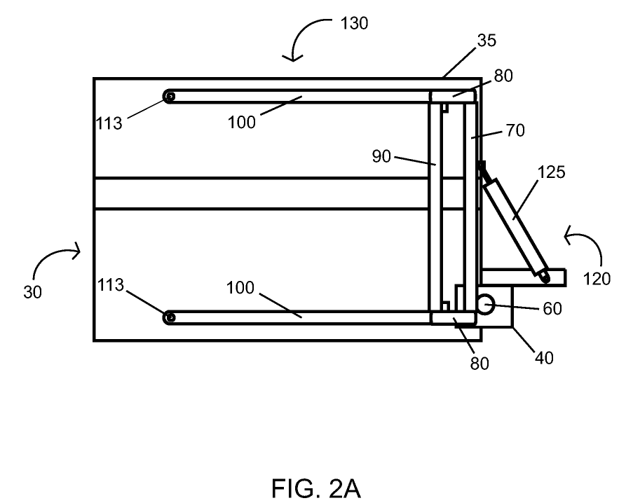

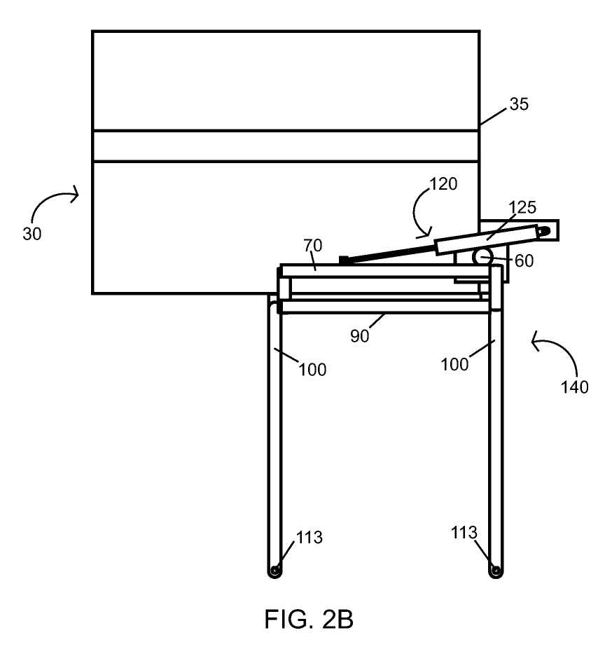

In use, the mounting plates 70,90, arms 80, and forks 100 may rotate from an inside position 130 inside the vehicle 30 to a substantially outside position 140 outside of the vehicle 30 (FIGS. 2A and 5) about the pivot rod 60. When moving into the inside position 130, each linear actuator 110 is in the raised position 112 (FIG. 3B). Once the inside position 130 is achieved, each linear actuator 110 may be lowered slightly as desired by the occupant 28, such that the wheelchair 20 wheels contact the floor of the vehicle 30, locking the wheelchair 20 in place in a driving position (FIG. 5). When the mounting plates 70,90, arms 80, and forks 100 are rotated into the outside position 140, each linear actuator 110 may be changed from the raised position 112 to a lowered position 111 (FIGS. 3A and 5).

Preferably at least one horizontal linear actuator 120 is fixed between the vehicle 30 and the rear mounting plate 70. The horizontal linear actuator 120 is adapted to selectively rotate the forward mounting plate 90, arms 80, and the pair of forks 100 between the inside and outside positions 130,140 (FIGS. 2A and 2B). In such an embodiment, a second actuator control 125 is adapted to activate the horizontal linear actuator 120, and is mounted to the forward mounting plate 90 preferably with the actuator control 118. As such, the wheelchair occupant 28 may reach both actuator controls 118,125 when the wheelchair 20 is fully engaged to the pair of forks 110, or by remote control (not shown) when outside of the vehicle 30 and not engaged to the forks 110. Additional actuator controls 118,125 may be mounted on the vehicle 30 so as to be accessible when the occupant 28 is outside of the vehicle 30 (not shown).

Preferably each actuator 110,120 is a motor-driven screw drive 115,125, as illustrated in FIGS. 1 and 2A. Alternately, however, either actuator 110,120 may be a hydraulic cylinder (not shown).

While a particular form of the invention has been illustrated and described, it will be apparent that various modifications can be made without departing from the spirit and scope of the invention. For example, various types of linear actuators 110,120 may be used as suitable for the present application. Accordingly, it is not intended that the invention be limited, except as by the appended claims.

What is claimed is:

1. A system for lifting a wheelchair into and out of a vehicle, comprising:
a bearing mount fixed to the vehicle, the bearing mount including a bearing mounting means and a vehicle mounting means;
a bearing means fixed to the bearing mounting means of the bearing mount;
a pivot rod having an upper end and a lower end, the lower end of the pivot rod being rotationally captured within the bearing means;
a rear mounting plate fixed to the upper end of the pivot rod, the rear mounting plate including a pair of arm mounting means;
a pair of parallel arms, each pair pivotally mounted at a rear end thereof to one of the arm mounting means, a forward end of each parallel arm pivotally mounted to a substantially vertical front mounting plate such that the arms and mounting plates form a parallelogram therebetween and the mounting plates remain oriented substantially consistently;
a pair of forks mounted to the forward mounting plate, the forks adapted to engage a pair of fork receivers fixed to the wheelchair;
at least one vertical linear actuator fixed between the mounting plates, the vertical linear actuator adapted to selectively raise and lower the forward mounting plate and forks with respect to the vehicle;
whereby the mounting plates, arms, and pair of forks may rotate from an inside position to a substantially outside position, the forks raising and lowering the wheelchair.

2. The system of claim 1 further including at least one horizontal linear actuator fixed between the vehicle and the rear mounting plate, the horizontal linear actuator adapted to selectively rotate the forward mounting plate, arms, and the pair of forks between the inside and outside position.

3. The system of claim 1 wherein the bearing mounting means of the bearing mount is an aperture in the bearing mount

4. The system of claim 1 wherein the vehicle mounting means of the bearing mount is at least two apertures in the bearing mount through each of which a bolt may be used to fasten the bearing mount to the vehicle.

5. The system of claim 1 wherein the bearing means is a pair of ball bearing housings for rotationally capturing an inner ring therein, the inner ring frictionally receiving the lower end of the pivot rod.

6. The system of claim 1 wherein the mounting plates are maintained in a generally vertical orientation.

7. The system of claim 1 wherein an actuator control is adapted to activate each linear actuator and is mounted to the forward mounting plate, whereby an occupant of the wheelchair may reach the actuator control when the wheelchair is fully engaged to the pair of forks.

8. The system of claim 1 wherein the bearing mount is fixed to a portion of a frame of the vehicle proximate a driver's side door.

9. The system of claim 1 wherein a second actuator control is adapted to activate the horizontal linear actuator and is mounted to the forward mounting plate, whereby an occupant of the wheelchair may reach the second control when the wheelchair is fully engaged to the pair of forks.

10. The system of claim 1 wherein the first linear actuator is a motor-driven screw drive.

11. The system of claim 1 wherein the second linear actuator is a motor-driven screw drive.
